(19) United States
(12) Patent Application Publication
(10) Pub. No.: US 2022/0146996 A1
(43) Pub. Date: May 12, 2022

(54) REWARD GENERATION METHOD TO REDUCE PEAK LOAD OF ELECTRIC POWER AND ACTION CONTROL APPARATUS PERFORMING THE SAME METHOD

(71) Applicant: Electronics and Telecommunications Research Institute, Daejeon (KR)

(72) Inventor: cheol-ho SHIN, Sejong-si (KR)

(73) Assignee: Electronics and Telecommunications Research Institute, Daejeon (KR)

(21) Appl. No.: 17/502,646

(22) Filed: Oct. 15, 2021

(30) Foreign Application Priority Data
Nov. 6, 2020 (KR) 10-2020-0147996

(51) Int. Cl. G05B 13/04; G05B 13/02; G06Q 50/06; H02J 3/14

(52) U.S. Cl. CPC G05B 13/047; G05B 13/0265; H02J 2203/10; H02J 3/144; H02J 2203/20; G06Q 50/06

(57) ABSTRACT

Provided are a reward generation method for reducing a peak load of power and an action control apparatus for performing the method. The reward generation method generates a reward according to a continuous energy storage system (ESS) action to reduce a peak load of a building by applying power consumption data monitored in the building to an artificial intelligence (AI)-based reinforcement learning scheme.

### CROSS-REFERENCE TO RELATED APPLICATION

This application claims the benefit of Korean Patent Application No. 10-2020-0147996 filed on Nov. 6, 2020, in the Korean Intellectual Property Office, the entire disclosure of which is incorporated herein by reference for all purposes.

### BACKGROUND

### 1. Field of the Invention

One or more example embodiments relate to a reward generation method for reducing a peak load of power and an action control apparatus for performing the method, and more particularly, to a method of controlling an action of an energy storage system to manage a peak load of power used in a building.

### 2. Description of the Related Art

As energy demand is rapidly increasing all over the world, the use of renewable energy is recommended accordingly. A key factor in using the renewable energy is to enable power to be efficiently used by storing or discharging energy produced by an energy storage system.

Currently, as a method of managing a power demand using an energy storage system (ESS), an ESS operation scheduling method is used to reduce a maximum peak load by charging power energy in a light load time and by discharging power energy in a maximum load time in consideration of a seasonal load time. However, the ESS operation scheduling method is determined based on a result of analyzing power consumption data monitored from a load of a power system to enhance efficiency of a power demand management. Therefore, cluster analysis and error correction techniques need to be additionally used to more accurately predict a power consumption.

In addition, the ESS operation scheduling method employs a long-short term memory (LSTM)-based ESS operation scheduling scheme for a maximum demand power reduction that trains a neural network to minimize an error between optimal ESS discharge power analyzed according to optimal ESS discharge power and predicted discharge power by performing ESS scheduling to constantly maintain an amount of power that flows in a power system using a prediction result or by analyzing collected power consumption data.

However, the aforementioned methods simply predict a result in which an abnormal state or a recent power use pattern is not applied by employing a method of predicting current demand power generally using only previous data. Also, the aforementioned methods are based on analysis of long-term power consumption data measured in a specific building. Therefore, an additional analysis based on professional knowledge is required to apply to another building with a different power load pattern.

### SUMMARY

Example embodiments provide an apparatus and method that may perform an optimal energy storage system (ESS) control for reducing a peak load of a building by automatically analyzing and learning power consumption data monitored in a building, without performing a prior analysis process on the power consumption data based on professional knowledge, with respect to all buildings in which power is used.

Example embodiments provide an apparatus and method that may generate a reward according to a continuous ESS action that is a key factor to train a reinforcement learning model for a peak load reduction of a building by using an artificial intelligence (AI)-based reinforcement learning scheme for performing an optimal ESS control.

According to an aspect, there is provided a reward generation method including determining a maximum variable load of a building based on power consumption data monitored in the building within a collection section based on a reinforcement learning model; generating reward values according to an action of an energy storage system for each piece of power consumption data using the maximum variable load; and generating a reward for controlling the energy storage system by classifying the reward values based on a daily basis on which an action of the energy storage system is to be applied.

The determining of the maximum variable load of the building may include receiving n pieces of power consumption data collected every control time unit according to a power demand of the building during a preset collection period; determining a maximum load and a minimum load of the building based on the n pieces of power consumption data; and determining the maximum variable load of the building based on the maximum load and the minimum load of the building.

The generating of the reward values may include generating n actions of the energy storage system that interact based on the n pieces of power consumption data every control time unit, and determining reward values corresponding to the generated n actions of the energy storage system.

The generating of the reward values may include verifying power consumption data included in a sample section in which an i^{th} action among the n actions of the energy storage system is to be applied; determining power indices of the power consumption data included in the sample section based on the maximum variable load and the minimum load of the building; setting a reward index corresponding to a setting stage by classifying the power indices of the power consumption data included in the sample section according to the setting stage; and determining a reward value for the i^{th} action of the energy storage system using the reward index.

Each of the reward values may be a value that is defined as a negative number or a positive number for at least one of a charging action, a discharging action, and a standby action of the energy storage system to be performed at a time of controlling the energy storage system of the building.

The generating of the reward may include generating a reward for controlling the energy storage system from reward values by an action of the energy storage system that is continuously performed on a daily basis.

According to another aspect, there is provided an action control method including generating an optimal reinforcement learning model capable of controlling an energy storage system by receiving power consumption data collected in a building as an input and by repeatedly learning a control policy for reducing a power peak load; generating energy storage system control information of a subsequent stage by inputting current power data to the reinforcement learning model of which learning is completed; and controlling the energy storage system using the energy storage system control information generated in the reinforcement learning model.

The generating of the reinforcement learning model may include generating the optimal reinforcement learning model such that daily rewards are maximized through repeated learning of the reinforcement learning model using previously collected power data to achieve the control policy for reducing the power peak load.

The controlling of the energy storage system may include generating energy storage system control information to be operated in a subsequent control time unit by inputting power data of a current time to the optimal reinforcement learning model of which learning is completed; controlling an action of the energy storage system such that the energy storage system performs a discharging action according to energy storage system discharging control information; and controlling an action of the energy storage system such that the energy storage system performs a charging action according to energy storage system charging control information.

According to still another aspect, there is provided a processor configured to receive n pieces of power consumption data collected every control time unit according to a power demand of the building during a preset collection period, to determine a maximum load and a minimum load of the building based on the n pieces of power consumption data, and to determine the maximum variable load of the building based on the maximum load and the minimum load of the building.

The processor may be configured to generate n actions of the energy storage system that interact based on the n pieces of power consumption data every control time unit, and to determine reward values corresponding to the generated n actions of the energy storage system.

The processor may be configured to verify power consumption data included in a sample section to which an i^{th} action among the n actions of the energy storage system is to be applied, to determine power indices of the power consumption data included in the sample section based on the maximum variable load and the minimum load of the building, to set a reward index corresponding to a setting stage by classifying the power indices of the power consumption data included in the sample section according to the setting stage, and to determine a reward value for the i^{th} action of the energy storage system using the reward index.

Each of the reward values may be a value that is defined as a negative number or a positive number for at least one of a charging action, a discharging action, and a standby action of the energy storage system to be performed at a time of controlling the energy storage system of the building.

The processor may be configured to generate a reward for controlling the energy storage system from reward values by an action of the energy storage system that is continuously performed on a daily basis.

According to still another aspect, there is provided an action control apparatus for performing an action control method, the action control apparatus including a processor. The processor is configured to generate an optimal reinforcement learning model capable of controlling an energy storage system by receiving power consumption data collected in a building as an input and by repeatedly learning a control policy for reducing a power peak load, to generate energy storage system control information of a subsequent stage by inputting current power data to the reinforcement learning model of which learning is completed, and to control the energy storage system using the energy storage system control information generated in the reinforcement learning model.

The processor may be configured to generate the optimal reinforcement learning model such that daily rewards are maximized through repeated learning of the reinforcement learning model using previously collected power data to achieve the control policy for reducing the power peak load.

The processor may be configured to generate energy storage system control information to be operated in a subsequent control time unit by inputting power data of a current time to the optimal reinforcement learning model of which learning is completed, to control an action of the energy storage system such that the energy storage system performs a discharging action according to energy storage system discharging control information, and to control an action of the energy storage system such that the energy storage system performs a charging action according to energy storage system charging control information.

Additional aspects of example embodiments will be set forth in part in the description which follows and, in part, will be apparent from the description, or may be learned by practice of the disclosure.

A reward generation method according to example embodiments may perform an optimal ESS control for reducing a peak load of a building by automatically analyzing and learning power consumption data monitored in a building, without performing a prior analysis process on the power consumption data based on professional knowledge, with respect to all buildings in which power is used.

A reward generation method according to example embodiments may generate a reward according to a continuous ESS action that is a key factor to train a reinforcement learning model for a peak load reduction of a building by using an AI-based reinforcement learning scheme for performing an optimal ESS control.

A reward generation method according to example embodiments may naturally analyze and use power consumption data that is used as an input in a training process to maximize a reward using a reward generation scheme proposed herein.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a process of controlling an energy storage system based on a reinforcement learning model according to an example embodiment;

FIG. 2 illustrates a process of generating a reward for each stage based on a reinforcement learning model according to an example embodiment;

FIG. 3 is a graph showing a maximum load, a minimum load, and a maximum variable load of power consumption data according to an example embodiment;

FIG. 4 is a graph showing a relative energy index of power consumption data of a sample section according to an example embodiment;

FIG. 5 is a graph showing a power consumption pattern to be used as an input of reinforcement learning according to an example embodiment;

FIG. 6 is a graph showing a result before and after controlling an action of an energy storage system (ESS) according to an example embodiment;

FIG. 7 is a flowchart illustrating a reward generation method according to an example embodiment; and

FIG. 8 is a flowchart illustrating an action control method according to an example embodiment.

### DETAILED DESCRIPTION

The following structural or functional descriptions of example embodiments described herein are merely intended for the purpose of describing the example embodiments described herein and may be implemented in various forms. However, it should be understood that these example embodiments are not construed as limited to the illustrated forms.

Various modifications may be made to the example embodiments. Here, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described in the foregoing.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments will be described in detail with reference to the accompanying drawings.

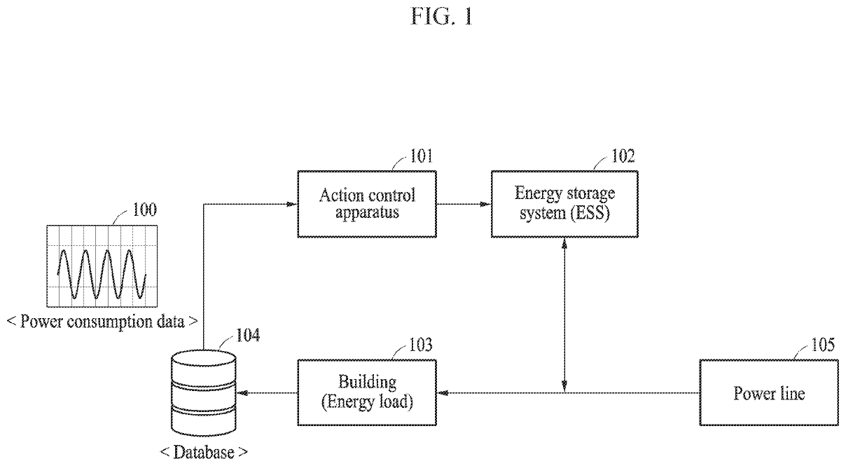

FIG. 1 illustrates a process of controlling an energy storage system based on a reinforcement learning model according to an example embodiment.

Referring to FIG. 1, an action control apparatus 101 may control an action of an energy storage system (ESS) 102 to reduce a peak load of a building 103 using a reinforcement learning model. The action control apparatus 101 may generate an optimal reinforcement learning model capable of controlling the energy storage system 102 by receiving power consumption data 100 collected in the building 103 as an input and by learning a control policy for reducing a power peak load based on the reinforcement learning model. The reinforcement learning model performs learning according to the control policy using the power consumption data 100 collected in the past, and controls an action of the energy storage system 102 of a subsequent stage by inputting current data to the reinforcement learning model of which learning is completed.

To train the reinforcement learning model of the action control apparatus 101, the action control apparatus 101 may receive n pieces of power consumption data 100 collected every control time unit according to a power demand of the building 103 during a preset collection period to reduce the peak load of power used in the building 103. The action control apparatus 101 may analyze and use the power consumption data 100 that is used as an input in a training process of receiving the power consumption data 100 as an input and maximizing a reward according to the purpose of the control policy, that is, the power peak load reduction.

The action control apparatus 101 may determine a maximum variable load representing a change in a magnitude of power based on the n pieces of power consumption data 100. The action control apparatus 101 may use data related to the power consumption data 100 collected in the building 103. The action control apparatus 101 may determine a maximum load and a minimum load of power used in the building 103 based on the collected power consumption data 100. The action control apparatus 101 may determine the maximum variable load based on the determined maximum load and minimum load of power.

The action control apparatus 101 may generate n actions of the energy storage system 102 that interact based on the n pieces of power consumption data 100 every control time unit based on the maximum variable load and may determine reward values corresponding to the generated n actions of the energy storage system 102.

The action control apparatus 101 may classify the reward values based on a daily basis on which an action of the energy storage system 102 is to be applied.

Therefore, although the action control apparatus 101 applies to a building with a different power load pattern, if the collected power consumption data 100 is input, the action control apparatus 101 may optimally control the energy storage system 102 by automatically analyzing and learning the power consumption data 100.

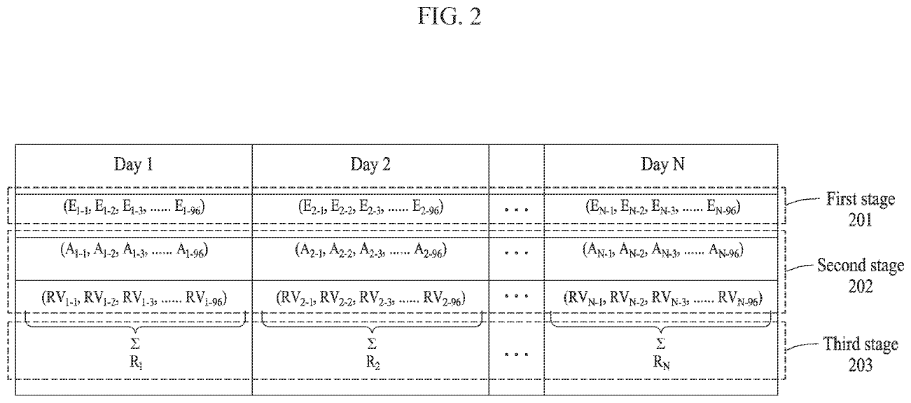

FIG. 2 illustrates a process of generating a reward for each stage based on a reinforcement learning model according to an example embodiment.

Referring to FIG. 2, as various demand management methods for managing a peak load of power, the action control apparatus 101 may interact with the energy storage system (ESS) 102 capable of charging and discharging power. Herein, the action control apparatus 101 may perform a process of receiving the reinforcement learning-based power consumption data 100 as an input and learning a control policy.

The action control apparatus 101 may automatically analyze the power consumption data 100 collected while monitoring the building 103 to be suitable for the purpose of reducing a peak load of the building 103 without performing a separate prior analysis process based on professional knowledge. Here, the reinforcement learning model may be trained such that a reward that is a sum of reward values (RV: Reward_Value) by a continuous control action of the energy storage system 102 during a day (24 hours) may be maximized. The action control apparatus 101 may perform charging when a reward index (Reward_index) is small, and may perform discharging when the reward index is large. In this manner, the reinforcement learning model may be automatically trained to maximize a reward that is a sum of reward values according to charging and discharging of a daily basis.

To apply the AI-based reinforcement learning model, the action control apparatus 101 may receive the power consumption data 100 of the building 103 as an input through a database 104 and may automatically analyze the power consumption data 100.

In detail, the action control apparatus 101 may generate a reward according to a control action of the energy storage system 102, that is, an ESS charging/discharging action for reducing a peak load of power based on the reinforcement learning model. The action control apparatus 101 may perform an action through the following three stages.

In first stage 201, the action control apparatus 101 may calculate a maximum load and a minimum load using n pieces of power consumption data (train data) of a predetermined section to be used to train an ESS control system and may determine a maximum variable load according to the maximum load and the minimum load.

In second stage 202, the action control apparatus 101 may generate n reward values according to n control actions of the energy storage system 102 based on n pieces of power consumption data every control time unit (e.g., every 15 minutes) using the minimum load and the maximum variable load.

In third stage 203, the action control apparatus 101 may set (**generate N final rewards to be used as a daily reward by classifying n reward values that are obtained using n pieces of power consumption data including N days, based on a daily basis and by adding up all reward values included in the daily basis.

For example, the action control apparatus 101 may obtain a final reward to be applied to an i^{th} day (1 day including 96 samples) using reward values of 15 minutes. The final reward may be determined according to the following Equation 1.

Ri=Σ(RVᵢ₋₁,RVᵢ₋₂, . . . RVᵢ₋₉₆) [Equation 1]

In Equation 1, Ri denotes a reward of the i^{th} day and RVᵢ₋₁ denotes a reward value that is generated by a first sample of the i^{th} day.

Therefore, the action control apparatus 101 may generate a reward according to an ESS charging/discharging action for reducing a peak load of power based on the reinforcement learning model.

The example embodiment is not dependent on power data collected in a specific building. Therefore, although the example embodiment applies to a building with a different power load pattern, if the collected power consumption data 100 is input, it is possible to perform an optimal ESS control through automatic analysis and learning.

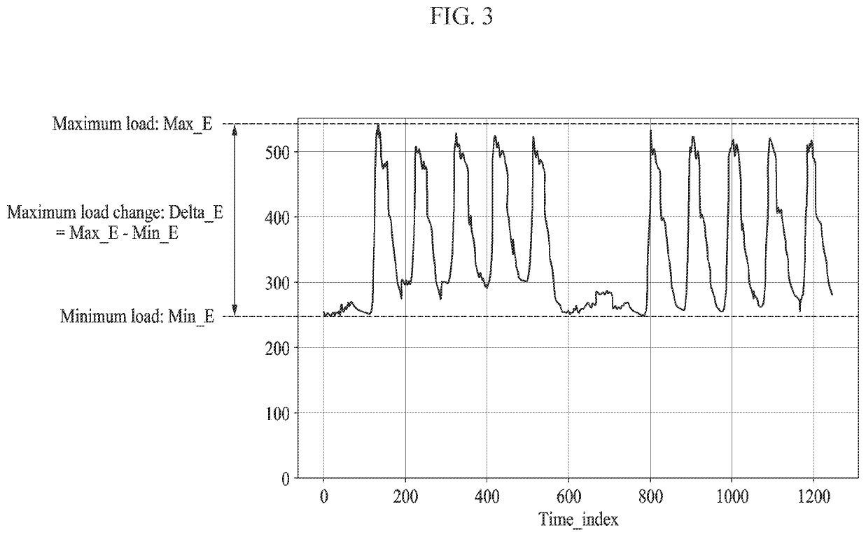

FIG. 3 is a graph showing a maximum load, a minimum load, and a maximum variable load of power consumption data according to an example embodiment.

Referring to FIG. 3, to reduce a peak load of power used in a building, an action control apparatus may receive n pieces of power consumption data collected every control time unit according to a power demand of the building during a preset collection period. For example, the action control apparatus may use n pieces of power consumption data (train data) monitored in a building for a predetermined period (e.g., a week, a month, a year, etc.) to be used when training the reinforcement learning model.

The action control apparatus may apply the n pieces of power consumption data to the reinforcement learning model and may determine a maximum variable load representing a change in a magnitude of power. The action control apparatus may determine a maximum load (Max_E) and a minimum load (Min_E) of power to be used in the building using the n pieces of power consumption data. The action control apparatus may determine the maximum variable load based on the maximum load and the minimum load of power.

Max_E=Max[E1,E2, . . . En−2,En−1,En] [Equation 2]

Here, Equation 2 may be used to calculate the maximum load of power from the n pieces of power consumption data collected in the building.

Min_E=Min[E1,E2, . . . En−2,En−1,En] [Equation 3]

Here, Equation 3 may be used to calculate the minimum load of power from the n pieces of power consumption data collected in the building.

Delta_E=Max_E−Min_E [Equation 4]

Here, Equation 4 may be used to calculate the maximum variable load using the maximum load and the minimum load of power.

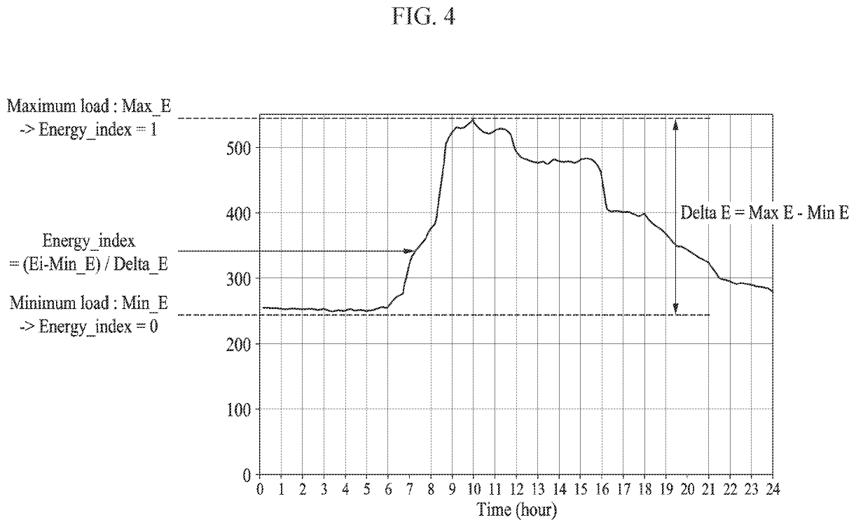

FIG. 4 is a graph showing a relative energy index of power consumption data of a sample section according to an example embodiment.

Referring to FIG. 4, an action control apparatus may generate n reward values (RVs) corresponding to n pieces of power consumption data using a maximum variable load.

That is, the action control apparatus may generate the n reward values according to n control actions of an energy storage system corresponding to then pieces of power consumption data collected every control time unit. Here, a control action of the energy storage system may correspond to one of charging, discharging, and standby of the energy storage system. For example, the control time unit refers to a time for collecting power consumption data and, herein, 15 minutes may be set as the control time unit.

The action control apparatus may determine an energy index (Energy_index) according to the following Equation 5, based on the maximum variable load (Delta_E) obtained from the power consumption data. That is, the action control apparatus may calculate a relative power ratio (Energy_index) of power consumption data (Ei) of a sample section in which an i^{th} control action of the energy storage system is to be applied using the maximum variable load (Delta_E) obtained from the monitored entire power consumption data.

Energy_index=(Ei_Min_E)/Delta_E [Equation 5]

Referring to Equation 5, the energy index may be determined based on the power consumption data, the minimum load of power, and the maximum variable load. Here, the energy index may represent a relative power ratio of power consumption data (Ei) of the sample section in which the i^{th} action of the energy storage system is to be applied. The energy index may be set as a setting stage of a specific unit depending on the purpose of the sample section. The specific unit may refer to a unit used to classify an action of the energy storage system.

A reward value to be generated according to an i^{th} control action of the energy storage system proposed herein may be set to have a high reward index according to an increase in the energy index, and a setting stage of the energy index may be set as various stages to be suitable for the purpose. For example, the setting stage of the energy index may be divided into five stages. A reward index by an energy index of each divided stage may be set as the following Equation 6.

If Energy-index is less than α₁, Reward_index=β₀*Reward_Weight

If Energy-index is greater than or equal to α₁ and less than α₂, Reward_index=β₁*Reward_Weight

If Energy-index is greater than or equal to α₂ and less than α₃, Reward_index=β₂*Reward_Weight

If Energy-index is greater than or equal to α₃ and less than α₄, Reward_index=β₃*Reward_Weight

If Energy-index is greater than or equal to α₄ and less than α₅, Reward_index=β₄*Reward_Weight

If Energy-index is greater than or equal to α₅, Reward_index=β₅*Reward_Weight [Equation 6]

Here, a parameter (α₁<α₂<α₃<α₄<α₅) that denotes a value of an energy index, a parameter (β₁<β₂<β₃<β₄<β₅) that represents a value of a reward index, and a reward (Reward_Weight) may be constants.

The action control apparatus may determine the reward value according to the i^{th} control action of the energy storage system (ESS_action) based on the following Equation 7.

RV=ESS_action*Reward_index [Equation 7]

An i^{th} reward value (RV) by the i^{th} control action of the energy storage system may be finally determined according to the following conditions.

\textcircled{1} If ESS_action=charging (1), RV=−Reward_index

\textcircled{2} If ESS_action=discharging (−1), RV=Reward_index

\textcircled{3} If ESS_action=standby (0), RV=0

The reward index may have a negative value when the control action of the energy storage system corresponds to charging and may have a positive value when the control action of the energy storage system corresponds to discharging since a final reward includes a sum of reward values by actions of the energy storage system classified based on a daily basis on which the action of the energy storage system is to be applied, and it intends to charge when the reward index (Reward_index) is small and to discharge when the reward index (Reward_index) is large, thereby maximizing a daily reward.

Therefore, ESS specifications of the following Table 1 are used as an example embodiment for verifying a reinforcement learning model training process of the action control apparatus and a training result thereof. Referring to Table 1, the capacity of the energy storage system is assumed as 100 kWh, and a maximum charging amount and discharging amount are set as 30 kW.

TABLE 1

| | Capacity (kWh) | PCS (kW) |
|---|---|---|
| ESS specifications | 100 | 30 |

The action control apparatus may set the above energy index, reward index, control action of the energy storage system, and parameter value to generate n reward values to be applied to the reward weight based on the above Table 1, as follows:

\textcircled{1} α₁=0.5, α₂=0.7, α₃=0.8, α₄=0.9, α₅=1.0

\textcircled{2} β₀=0.2, β₁=0.5, β₂=0.8, β₃=0.9, β₄=1.0, β₅=1.2

\textcircled{3} ESS_action=−1 (charging) or 1 (discharging) or 0 (standby)

\textcircled{4} Reward_Weight=100

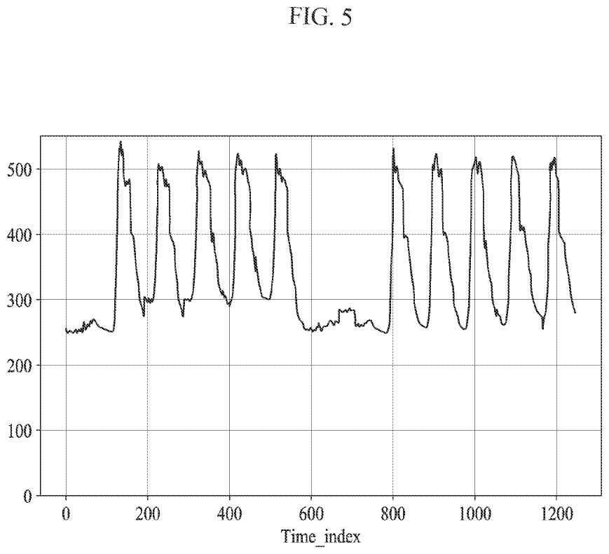

FIG. 5 is a graph showing a power consumption pattern to be used as an input of reinforcement learning according to an example embodiment.

The graph of FIG. 5 may represent a result of a power consumption pattern of a building based on power consumption data collected in the building for about 2 weeks.

Accordingly, the action control apparatus may use n pieces of power consumption data related to power consumed in the building as input data of an reinforcement learning model. An ESS control system may monitor and collect power consumption data every 15 minutes based on a preset control time unit. The power consumption data may be collectively collected through a separate database that interacts with the building. The action control apparatus may extract the collectively collected power consumption data from the database and may generate a power consumption pattern of the building used for the reinforcement learning model.

For example, FIG. 5 shows a power consumption pattern of 2 weeks that is a portion of the entire section used as train data of the reinforcement learning model. FIG. 5 shows an example of power consumption data collected every 15 minutes. Here, 1 day includes 96 pieces of power consumption data and 2 weeks includes 1,344 pieces of power consumption data corresponding to 96*2 week (14 days).

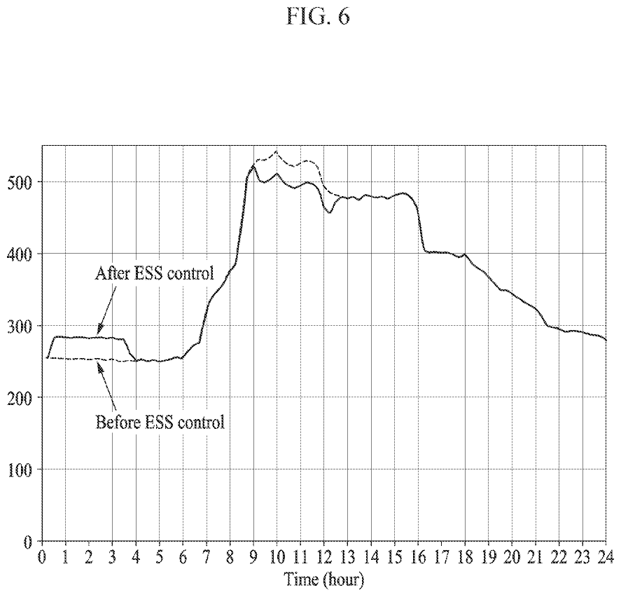

FIG. 6 is a graph showing a power energy consumption result of a daily basis of a building before and after controlling an action of an energy storage system (ESS) according to an example embodiment.

The graph of FIG. 6 shows a result of analyzing a power peak load reduction performance of an ESS control system based on reinforcement learning by applying a reward generation method for reducing a peak load.

Referring to the graph, it is possible to verify that the power peak load of the building is being reduced by controlling the energy storage system continuously for 24 hours, that is, for a day using the trained reinforcement learning model.

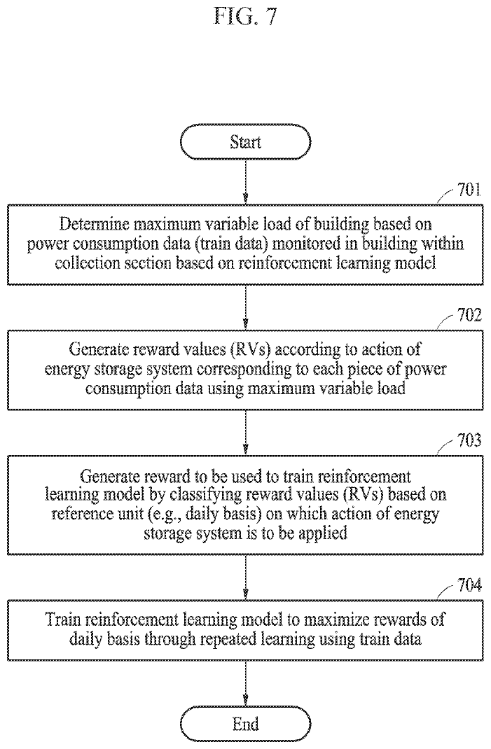

FIG. 7 is a flowchart illustrating a reward generation method according to an example embodiment.

Referring to FIG. 7, in operation 701, an action control apparatus according to an example embodiment may determine a maximum variable load of a building based on power consumption data (train data) monitored in the building within a collection section based on a reinforcement learning model. In detail, the action control apparatus may receive n pieces of power consumption data collected every control time unit according to a power demand of the building during a preset collection period to reduce a peak load of power used in the building.

The action control apparatus may determine a maximum variable load that represents a change in power magnitude of the n pieces of power consumption data. The action control apparatus may use data related to the power consumption data collected in the building. The action control apparatus may determine a maximum load and a minimum load of power used in the building based on the collected power consumption data. The action control apparatus may determine the maximum variable load based on the determined maximum load and minimum load of power.

In operation 702, the action control apparatus may generate n reward values (RVs) according to n actions of the energy storage system corresponding to the n pieces of power consumption data using the maximum variable load. That is, the action control apparatus may generate n actions of the energy storage system that interact based on the n pieces of power consumption data every control time unit based on the maximum variable load and may determine reward values according to the n actions of the energy storage system.

The action control apparatus may determine the energy index (Energy_index) of an i^{th} piece of power consumption data among the n pieces of power consumption data based on the maximum variable load and the minimum load of the building as shown in FIG. 4.

The action control apparatus may classify power indices of the n pieces of power consumption data based on a setting stage and may set a reward index corresponding to the setting stage. Here, the action control apparatus may determine n reward values according to the n actions of the energy storage system that interact based on a reward index and a reward weight that are differently applied based on each corresponding energy index, and the n pieces of power consumption data, as represented by Equation 7.

Here, the reward values may be defined as a negative number or a positive number for at least one of a charging action, a discharging action, and a standby action of the energy storage system to be performed at a time of controlling the energy storage system of the building.

In operation 703, the action control apparatus may generate a reward to be used to train the reinforcement learning model by classifying the reward values based on a daily basis on which an action of the energy storage system is to be applied.

In detail, the action control apparatus may set N final rewards to be used as a daily reward by classifying n reward values that are obtained using the n pieces of power consumption data including N days, based on a daily basis and by adding up all reward values included in the daily basis.

In operation 704, the reinforcement learning model in the action control apparatus may be trained to maximize the N final rewards of the daily basis through repeated learning using the power consumption data (train data) monitored in the building within the collection period. Therefore, the action control apparatus may perform charging when a reward index (Reward_index) is small and may perform discharging when the reward index is large, such that a reward that is a sum of reward values according to charging and discharging of a daily basis may be maximized.

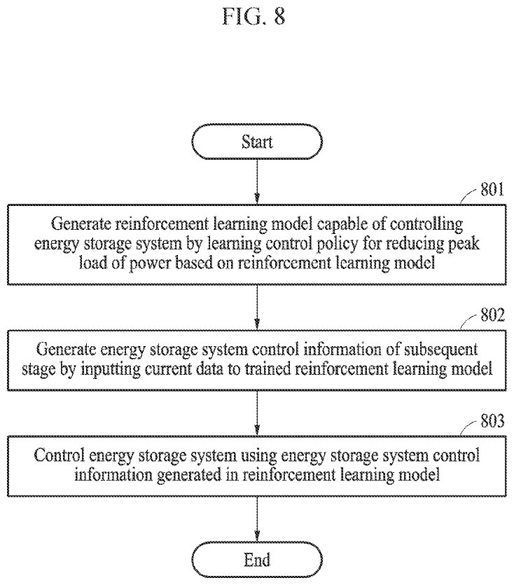

FIG. 8 is a flowchart illustrating an action control method according to an example embodiment.

Referring to FIG. 8, in operation 801, an action control apparatus according to an example embodiment may generate an optimal reinforcement learning model capable of controlling an energy storage system through the process of FIG. 7 by receiving power consumption data collected in a building as an input based on the reinforcement learning model and by learning a control policy for reducing a peak load of power.

In operation 802, the action control apparatus may generate energy storage system control information of a subsequent stage by inputting current power consumption data to the optimal reinforcement learning model of which learning is completed.

In operation 803, the action control apparatus may control the energy storage system using the energy storage system control information generated in the reinforcement learning model.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A reward generation method comprising:
determining a maximum variable load of a building based on power consumption data monitored in the building within a collection section based on a reinforcement learning model;
generating reward values according to an action of an energy storage system for each piece of power consumption data using the maximum variable load; and
generating a reward for controlling the energy storage system by classifying the reward values based on a daily basis on which an action of the energy storage system is to be applied.

2. The reward generation method of claim 1, wherein the determining of the maximum variable load of the building comprises:
receiving n pieces of power consumption data collected every control time unit according to a power demand of the building during a preset collection period;
determining a maximum load and a minimum load of the building based on the n pieces of power consumption data; and
determining the maximum variable load of the building based on the maximum load and the minimum load of the building.

3. The reward generation method of claim 2, wherein the generating of the reward values comprises:
generating n actions of the energy storage system that interact based on the n pieces of power consumption data every control time unit, and determining reward values corresponding to the generated n actions of the energy storage system.

4. The reward generation method of claim 3, wherein the generating of the reward values comprises:
verifying power consumption data included in a sample section in which an i^{th} action among the n actions of the energy storage system is to be applied;
determining power indices of the power consumption data included in the sample section based on the maximum variable load and the minimum load of the building;
setting a reward index corresponding to a setting stage by classifying the power indices of the power consumption data included in the sample section according to the setting stage; and
determining a reward value for the i^{th} action of the energy storage system using the reward index.

5. The reward generation method of claim 1, wherein each of the reward values is a value that is defined as a negative number or a positive number for at least one of a charging action, a discharging action, and a standby action of the energy storage system to be performed at a time of controlling the energy storage system of the building.

6. The reward generation method of claim 1, wherein the generating of the reward comprises:
generating N final rewards to be used as a daily reward by classifying n reward values that are obtained using n pieces of power consumption data including N days, based on a daily basis and by adding up all reward values included in the daily basis.

7. An action control method comprising:
generating an optimal reinforcement learning model capable of controlling an energy storage system by receiving power consumption data collected in a building as an input and by repeatedly learning a control policy for reducing a power peak load;
generating energy storage system control information of a subsequent stage by inputting current power data to the reinforcement learning model of which learning is completed; and
controlling the energy storage system using the energy storage system control information generated in the reinforcement learning model.

8. The action control method of claim 7, wherein the generating of the reinforcement learning model comprises generating the optimal reinforcement learning model such that daily rewards are maximized through repeated learning of the reinforcement learning model using previously collected power data to achieve the control policy for reducing the power peak load.

9. The action control method of claim 7, wherein the controlling of the energy storage system comprises:
generating energy storage system control information to be operated in a subsequent control time unit by inputting power data of a current time to the optimal reinforcement learning model of which learning is completed;
controlling an action of the energy storage system such that the energy storage system performs a discharging action according to energy storage system discharging control information; and
controlling an action of the energy storage system such that the energy storage system performs a charging action according to energy storage system charging control information.

10. An action control apparatus to perform a reward generation method, the action control apparatus comprising a processor,
wherein the processor is configured to
determine a maximum variable load of a building based on power consumption data monitored in the building within a collection section based on a reinforcement learning model,
generate reward values according to an action of an energy storage system for each piece of power consumption data using the maximum variable load, and
generate a reward for controlling the energy storage system by classifying the reward values based on a daily basis on which an action of the energy storage system is to be applied.

11. The action control apparatus of claim 10, wherein the processor is configured to
receive n pieces of power consumption data collected every control time unit according to a power demand of the building during a preset collection period,
determine a maximum load and a minimum load of the building based on the n pieces of power consumption data, and
determine the maximum variable load of the building based on the maximum load and the minimum load of the building.

12. The action control apparatus of claim 11, wherein the processor is configured to generate n actions of the energy storage system that interact based on the n pieces of power consumption data every control time unit, and to determine reward values corresponding to the generated n actions of the energy storage system.

13. The action control apparatus of claim 12, wherein the processor is configured to
verify power consumption data included in a sample section in which an i^{th} action among the n actions of the energy storage system is to be applied,
determine power indices of the power consumption data included in the sample section based on the maximum variable load and the minimum load of the building,
set a reward index corresponding to a setting stage by classifying the power indices of the power consumption data included in the sample section according to the setting stage, and
determine a reward value for the i^{th} action of the energy storage system using the reward index.

14. The action control apparatus of claim 10, wherein each of the reward values is a value that is defined as a negative number or a positive number for at least one of a charging action, a discharging action, and a standby action of the energy storage system to be performed at a time of controlling the energy storage system of the building.

15. The action control apparatus of claim 10, wherein the processor is configured to generate N final rewards to be used as a daily reward by classifying n reward values that are obtained using n pieces of power consumption data including N days, based on a daily basis and by adding up all reward values included in the daily basis.
